(19) United States
(12) Patent Application Publication
(10) Pub. No.: US 2021/0013589 A1
(43) Pub. Date: Jan. 14, 2021

(54) ANTENNA FRAME FOR USE WITH A MILLIMETER WAVE ANTENNA

(71) Applicant: Sony Corporation, Tokyo (JP)

(72) Inventors: Zhinong YING, Lund (SE); Kun ZHAO, Lund (SE)

(21) Appl. No.: 16/969,487

(22) PCT Filed: Jul. 31, 2018
(86) PCT No.: PCT/US2018/044579

§ 371 Date: Aug. 12, 2020

(51) Int. Cl. H01Q 1/24; H01Q 21/06; H01Q 9/04; H01Q 1/52

(52) U.S. Cl. CPC H01Q 1/243; H01Q 1/245; H01Q 1/52; H01Q 9/0407; H01Q 21/067

(57) ABSTRACT

An antenna frame for a wireless communication device includes an end portion having a thickness that varies along the width of the end portion, with the goal of reducing the radar cross section of the end portion to improve end-fire transmission of vertically polarized antenna elements. Embodiments of an antenna frame may include an end portion with a plurality of notches in the top edge and/or the bottom edge. These notches may be at least partially filled with a dielectric material to improve end-fire transmission of horizontally polarized antenna elements.

### TECHNICAL FIELD OF THE INVENTION

The technology of the present disclosure relates generally to antenna frames for mobile communication devices and, more particularly, to an antenna frame that supports transmission of millimeter wave frequencies.

### BACKGROUND

Communications standards such as 3G and 4G are currently in wide-spread use. It is expected that infrastructure to support 5G communications will soon be deployed. In order to take advantage of 5G, portable electronic devices such as mobile telephones will need to be configured with the appropriate communications components and corresponding structures. These components include an antenna that has one or more resonant frequencies in the millimeter (mm) wave range, which extends from 10 GHz to 100 GHz. In order to achieve performance with such small wavelengths, multiple antennas in the shape of an array have been utilized.

At mmWave frequencies, conventional antennas may induce a strong surface wave in the chassis (housing) of the mobile device that distorts the radiation pattern emitted by the antenna element. This distortion can lead to poor operational performance and may prevent antenna array applications. This phenomenon occurs since the electrical size of the chassis in terms of wavelength is much larger than the wavelength of the emitted signal. Similarly, a metal frame located in front of the antenna array can result in distortion of the antenna pattern and cause a significant blind area in the end-fire direction as seen in FIG. 1.

### SUMMARY

This disclosure describes an antenna frame for a wireless communication device. The antenna frame includes an end portion having a thickness that varies along the width of the end portion, with the goal of reducing the radar cross section of the end portion. This disclosure also describes an antenna frame having an end portion with a plurality of notches in the top edge and/or the bottom edge. These notches may be at least partially filled with a dielectric material.

According to aspects of the disclosure, an antenna frame for a wireless communication device includes an end portion. The end portion includes a first end, a second end spaced apart from the first end to define a length, an outer face that extends along the length, an inner face that extends along the length and is spaced apart from the outer face by a thickness, a top edge extending between the inner face and the outer face in the thickness direction and between the first end and the second end in the length direction at a top of the outer and inner faces, and a bottom edge extending between the inner face and the outer face in the thickness direction and between the first end and the second end in the length direction at a bottom of the outer and inner faces. The bottom edge is spaced apart from the top edge by a width, and the thickness of the end portion varies along the width of the end portion.

According to one embodiment of the antenna frame, the thickness of the end portion at the top edge and the bottom edge is less than the thickness of the end portion at any point in between the top edge and the bottom edge.

According to one embodiment of the antenna frame, the thickness varies along the width of the end portion such that the inner face has an arc shape.

According to one embodiment of the antenna frame, the thickness varies along the width of the end portion such that the end portion has a triangular cross section.

According to one embodiment of the antenna frame, the thickness varies along the width of the end portion such that the end portion has a trapezoidal cross section.

According to one embodiment of the antenna frame, the frame is at least partially constructed of a metal.

According to aspects of the disclosure, a wireless communication device includes the antenna frame. The antenna frame defines an interior space and the wireless communication device further comprises an antenna located within the interior space. The antenna comprises one or more antenna elements that are arranged substantially behind the end portion of the antenna frame.

According to one embodiment of the wireless communication device, the antenna is a vertically polarized antenna with a main lobe of radiation pattern facing outward through the end portion.

According to aspects of the disclosure, an antenna frame for a wireless communication device includes a first end, a second end spaced apart from the first end to define a length, an outer face that extends along the length, an inner face that extends along the length and is spaced apart from the outer face by a thickness, a top edge extending between the inner face and the outer face in the thickness direction and between the first end and the second end in the length direction at a top of the outer and inner faces, and a bottom edge extending between the inner face and the outer face in the thickness direction and between the first end and the second end in the length direction at a bottom of the outer and inner faces. At least one of the top edge or the bottom edge has a plurality of notches.

According to one embodiment of the antenna frame, both the top edge and the bottom edge have a plurality of notches.

According to one embodiment of the antenna frame, the plurality of notches are spaced periodically along the length of the end portion.

According to one embodiment of the antenna frame, one or more of the plurality of notches are at least partially filled with a dielectric material.

According to one embodiment of the antenna frame, the dielectric material is ceramic, glass, plastic, fiberglass, or a combination thereof.

According to one embodiment of the antenna frame, the wireless communication device is configured to transmit and receive communications using radio waves having a wavelength while passing through the dielectric material, and the plurality of notches have a depth measuring at least one-quarter of the wavelength.

According to one embodiment of the antenna frame, the plurality of notches have a metal molding.

According to one embodiment of the antenna frame, the frame is at least partially constructed of metal.

According to one embodiment of the antenna frame, the bottom edge is spaced apart from the top edge by a width, and the thickness of the end portion varies along the width of the end portion.

According to one embodiment of the antenna frame, the thickness of the end portion at the top edge and the bottom edge is less than the thickness of the end portion at any point in between the top edge and the bottom edge.

According to one embodiment of the antenna frame, the thickness varies along the width of the end portion such that the inner face has an arc shape.

According to one embodiment of the antenna frame, the thickness varies along the width of the end portion such that the end portion has a triangular cross section.

According to one embodiment of the antenna frame, the thickness varies along the width of the end portion such that the end portion has a trapezoidal cross section.

According to one embodiment of the antenna frame, the plurality of notches comprises a first notch having a first depth and a second notch having a second depth.

According to one embodiment of the antenna frame, the wireless communication device is configured to transmit and receive communications using radio waves having a first wavelength while passing through the dielectric material and radio waves having a second wavelength while passing through the dielectric material, and the first depth measuring at least one-quarter of the first wavelength and the second depth measuring at least one-quarter of the second wavelength.

According to aspects of the disclosure, a wireless communication device includes the antenna frame. The antenna frame defines an interior space and the electronic device further includes an antenna located within the interior space. The antenna includes one or more antenna elements that are arranged substantially behind the end portion of the antenna frame.

According to one embodiment of the wireless communication device, the antenna is a horizontally polarized antenna with a main lobe of radiation pattern facing outward through the end portion.

According to aspects of the disclosure, a wireless communication device includes the antenna frame. The antenna frame defines an interior space and the electronic device further includes an antenna located within the interior space. The antenna includes one or more antenna elements that are arranged substantially behind the end portion of the antenna frame.

According to one embodiment of the wireless communication device, the antenna is a dual-polarized antenna with a main lobe of radiation pattern facing outward through the end portion.

According to one embodiment of the wireless communication device, the antenna is a dual-band antenna with a main lobe of radiation pattern facing outward through the end portion.

According to aspects of the disclosure, an antenna includes the antenna frame and one or more antenna elements.

### BRIEF DESCRIPTION OF THE DRAWINGS

FIG. 1 is a polar plot diagram displaying the radiation pattern produced by an antenna array located behind a prior art metal antenna frame.

FIG. 2 is a perspective exploded view of an antenna frame surrounding antenna elements on a mobile communication device.

FIG. 3 is a cross-sectional view of a vertically polarized antenna located behind an embodiment of an antenna frame end portion.

FIG. 4 is a polar plot diagram displaying various radiation patterns produced by an antenna array located behind various metal antenna frame end portion designs.

FIG. 5 is a cross-sectional view of a vertically polarized antenna located behind an embodiment of an antenna frame end portion having a triangular cross-section.

FIG. 6 is a polar plot diagram displaying various radiation patterns produced by a vertically polarized antenna array located behind various metal antenna frame end portion designs.

FIG. 7 is a cross-sectional view of a vertically polarized antenna located behind another embodiment of an antenna frame end portion having an arc-shaped cross-section.

FIG. 8 is a cross-sectional view of a vertically polarized antenna located behind another embodiment of an antenna frame end portion having a trapezoidal cross-section.

FIG. 9 is a cross-sectional view of a horizontally polarized antenna located behind an embodiment of an antenna frame end portion.

FIG. 10 is perspective view of an antenna element located behind an embodiment of an antenna frame end portion having a plurality of notches.

FIG. 11 is a polar plot diagram displaying various radiation patterns produced by a horizontally polarized antenna array located behind various metal antenna frame end portion designs.

FIG. 12 is a perspective view of another embodiment of an antenna frame end portion having a triangular cross-section and a plurality of notches.

FIG. 13 is perspective view of another embodiment of an antenna frame end portion having a plurality of notches of different depths.

FIG. 14 is a perspective view of another embodiment of an antenna frame end portion having a triangular cross-section and a plurality of notches of different depths.

### DETAILED DESCRIPTION OF EMBODIMENTS

Embodiments will now be described with reference to the drawings, wherein like reference numerals are used to refer to like elements throughout. It will be understood that the figures are not necessarily to scale. Features that are described and/or illustrated with respect to one embodiment may be used in the same way or in a similar way in one or more other embodiments and/or in combination with or instead of the features of the other embodiments.

Described below, in conjunction with the appended figures, are various embodiments of antenna frame structures that may be used with mobile terminals, such as mobile telephones. Although some figures illustrate one antenna, it will be understood that the mobile terminal may include an array of the antennas for a beam shaping or sweeping application.

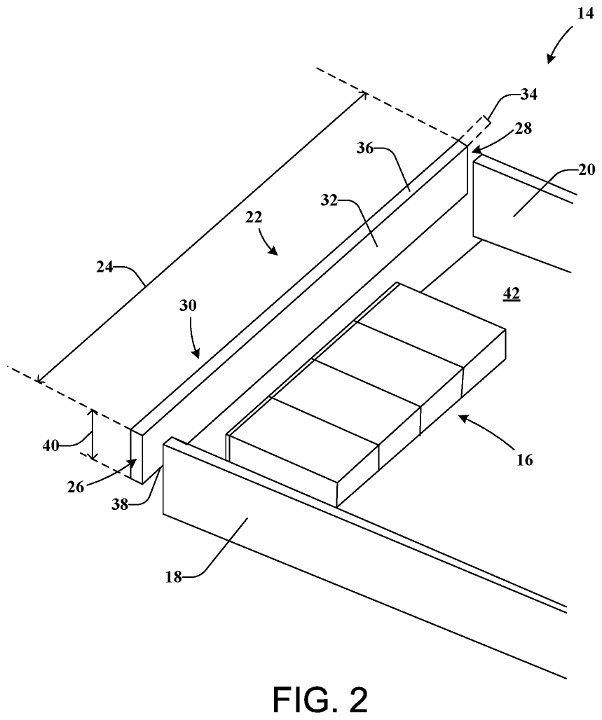

Referring to FIG. 2, illustrated is an exemplary basic structure of an antenna frame 14 for an antenna 16. Antenna frame 14 includes a first side portion 18 and a second side portion 20 parallel to the first side portion 18. The antenna frame 14 also includes an end portion 22. The end portion 22 extends along a length 24 from a first end 26 to a second end 28. The end portion 22 includes an outer face 30 extending along the length 24 and an inner face 32 that also extends along the length 24 and is spaced apart from the outer face 30 by a thickness 34. A top edge 36 extends in the thickness direction between the inner face 32 and the outer face 30, and extends between the first end 26 and the second end 28 in the length 24 direction at a top of the outer face 30 and the inner face 32. Similarly, a bottom edge 38 extends in the thickness direction between the inner face 32 and the outer face 30, and extends between the first end 26 and the second end 28 in the length 24 direction at a bottom of the outer face 30 and the inner face 32. The bottom edge 38 is spaced apart from the top edge 36 by a width 40. In some embodiments, the antenna frame 14 can be constructed completely or partially of metal. Types of metal used in construction of the frame can include aluminum or stainless steel, among others. The antenna frame 14 can define an interior space, in which an antenna 16 can be located and arranged substantially behind the end portion 22 of the frame 14. The antenna 16 can be further integrated within a wireless communication device and mounted on a substrate 42 such as a printed circuit board. The basic antenna frame 14 structure depicted in FIG. 2 can serve as the basis for the embodiments described below.

In some embodiments, the antenna frame 14 can be fabricated individually and integrated as part of a mobile communication device's casing. In other embodiments, antenna frame 14 can be a separate component that can be arranged inside of a mobile communication device. In still further embodiments, the antenna frame 14 can be integrated as part of the antenna 16 to form an antenna unit.

For the purposes of this disclosure, the term vertical polarization refers to radio waves that are polarized in the vertical direction, where the vertical direction is in the same direction as the width 40 of the corresponding end portion 22. The term horizontal polarization refers to radio waves that are polarized in the horizontal direction, where the horizontal direction is in the same direction as the length 24 of the corresponding end portion 22.

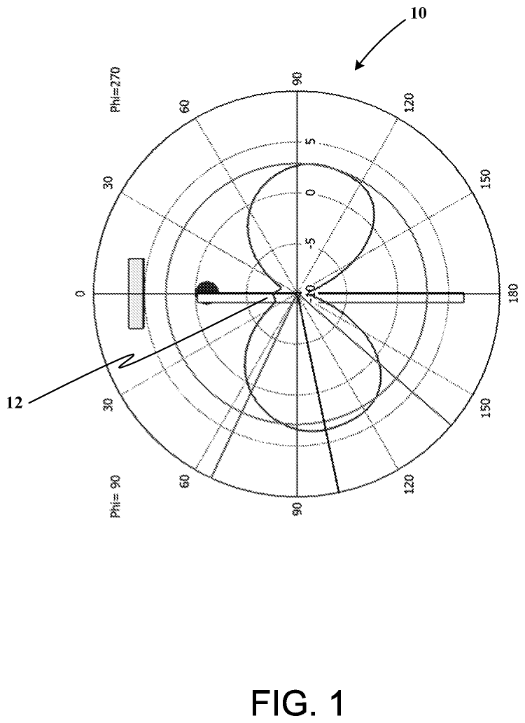

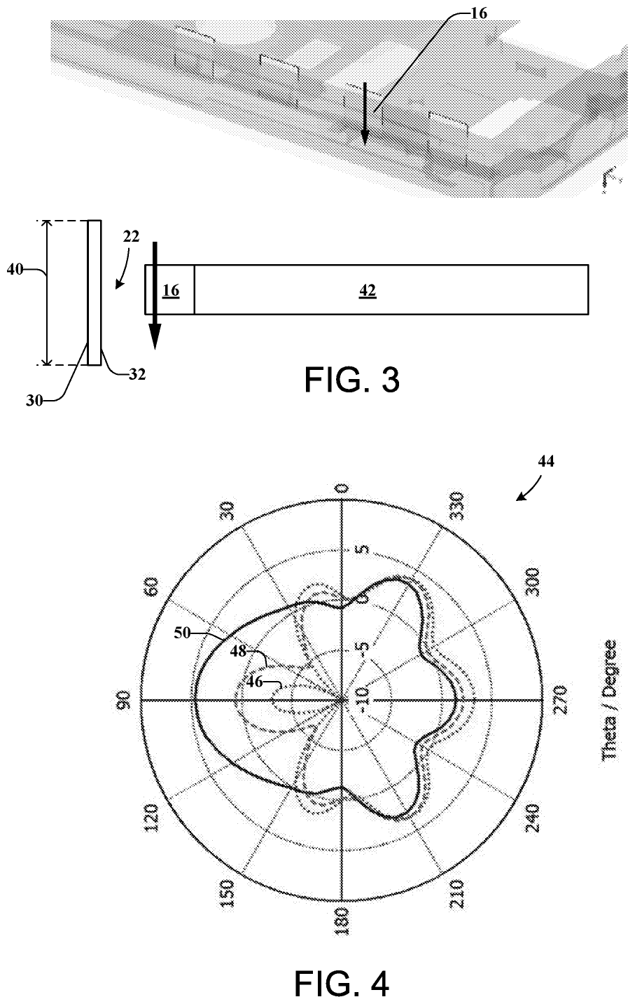

Turning now to FIG. 3, in this embodiment, the antenna 16 is vertically polarized as indicated by the vertical arrow. The antenna 16 is an edge-mounted antenna arranged substantially behind the end portion 22 of the frame 14. Using prior art antenna frames, the radiation pattern produced by the antenna has a significant blind spot 12 as seen in the diagram 10 displayed in FIG. 1. However, end-fire transmission from the antenna 16 can be improved by reducing the metal antenna frame 14 scattering effect. This may be accomplished by reducing the radar cross section of the metal antenna frame 14, and more specifically the end portion 22.

One method of reducing the radar cross section is to minimize the width 40 of the metal antenna frame's 14 end portion 22. Various widths 40 provide differing end-fire transmission results and radiation patterns as shown in the diagram 44 displayed in FIG. 4. Radiation pattern 46 results from an end portion 22 having a width 40 of 7 millimeters (mm). Radiation pattern 48 results from an end portion 22 having a width 40 of 5 mm. Radiation pattern 50 results from an end portion 22 having a width 40 of 3 mm. As shown in the diagram 44, a smaller width 40 of the end portion 22 results in a more desirable radiation pattern, with stronger radio waves, particularly in the direction of the main lobe oriented in the direction of the end portion 22 of the antenna frame 14. Such effect is seen when the antenna 16 is a vertically polarized antenna as in the embodiment displayed in FIG. 3. While reducing the width of the end portion 22 does not have any negative effect on transmission from a horizontally polarized antenna, such reduction does not provide any substantial benefit with respect to horizontally polarized antennas.

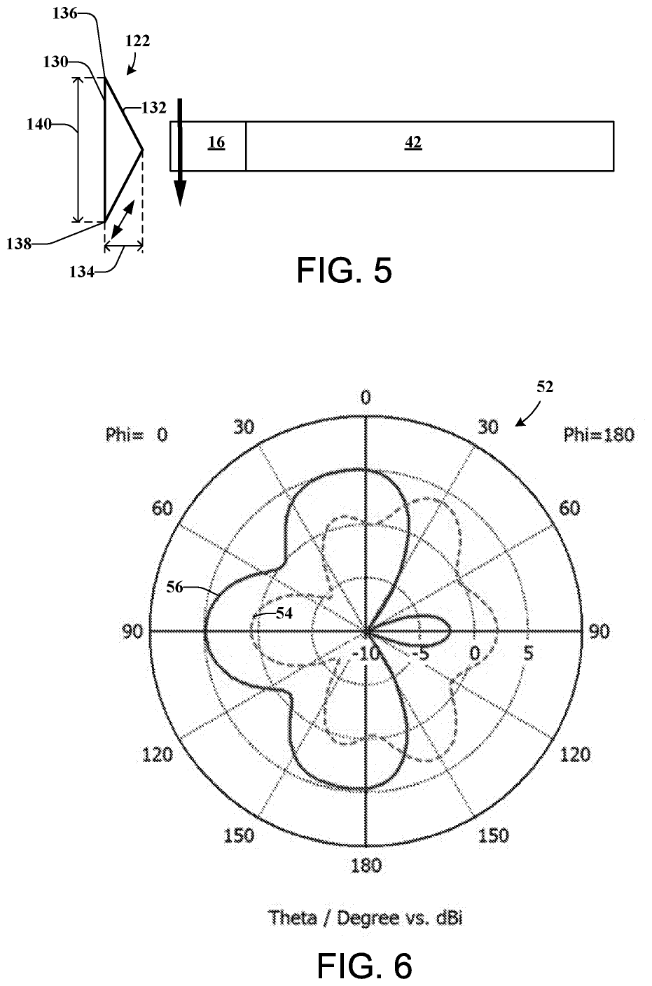

Another method of reducing the radar cross section is to vary the thickness 34 of the end portion 22 along the width 40 of the end portion 22. While varying the thickness 34 of the end portion 22 along the width 40 of the end portion 22 does not have any negative effect on transmission from a horizontally polarized antenna, such variation in thickness 34 along the width 40 of the end portion 22 does not provide any substantial benefit with respect to horizontally polarized antennas. Various embodiments of such end portions are described below with reference to FIGS. 5-8.

Turning now to FIG. 5, another exemplary embodiment of an end portion for an antenna frame is shown at 122. The end portion 122 is substantially the same as the above-referenced end portion 22, and consequently the same reference numerals but indexed by 100 are used to denote structures corresponding to similar structures in the end portions. In addition, the foregoing description of the end portion 22 is equally applicable to the end portion 122 except as noted below and depicted in the figures.

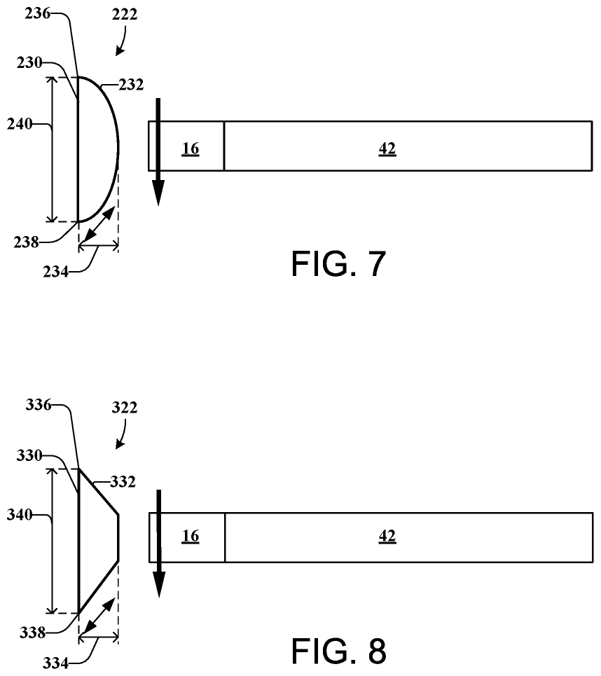

An exemplary end portion 122 is shown in FIG. 5. The width 140 of the end portion 122 extends from the top edge 136 to the bottom edge 138. The thickness 134 of the end portion 122 is varied along the width 140 of the end portion 122 such that the end portion 122 has a triangular or wedge-shaped cross section. The outer face 130 remains flat, and the inner face 132 is angled to create the triangular or wedge-shaped cross-section. This shape reduces back radiation of the radio waves from the antenna 16, thereby improving the radiation pattern as compared to an end portion 22 having a constant thickness 34 along its width 40, particularly in the direction of the main lobe oriented in the direction of the end portion 122. This improved radiation pattern is depicted in FIG. 6, which displays a diagram 52 showing the radiation patterns that result from using an end portion 22 having a width 40 of 5 mm and a constant depth 34, as compared to using an end portion 122 also having a width 40 of 5 mm, but having a triangular cross-section. Radiation pattern 54 corresponds to the use of end portion 22, and radiation pattern 56 corresponds to the use of end portion 122. Additional embodiments of the end portion 122 can have different cross-sectional shapes to reduce the radar cross section of the end portion 122. These additional embodiments are described below with reference to FIGS. 7 and 8.

Turning now to FIG. 7, another exemplary embodiment of an end portion for an antenna frame is shown at 222. The end portion 222 is substantially the same as the above-referenced end portion 22, and consequently the same reference numerals but indexed by 200 are used to denote structures corresponding to similar structures in the end portions. In addition, the foregoing description of the end portion 22 is equally applicable to the end portion 222 except as noted below and depicted in the figures.

The width 240 of the end portion 222 extends from the top edge 236 to the bottom edge 238. The thickness 234 of the end portion 222 is varied along the width 240 of the end portion 222 such that the end portion 222 has an arc-shaped cross section. The outer face 230 remains flat, and the inner face 232 has an arc-shape to create the arc-shaped cross-section. This shape reduces back radiation of the radio waves from the antenna 16, thereby improving the radiation pattern as compared to an end portion 22 having a constant thickness 34 along its width 40, particularly in the direction of the main lobe oriented in the direction of the end portion 222.

Turning now to FIG. 8, another exemplary embodiment of an end portion for an antenna frame is shown at 322. The end portion 322 is substantially the same as the above-referenced end portion 22, and consequently the same reference numerals but indexed by 300 are used to denote structures corresponding to similar structures in the end portions. In addition, the foregoing description of the end portion 22 is equally applicable to the end portion 322 except as noted below and depicted in the figures.

The width 340 of the end portion 322 extends from the top edge 336 to the bottom edge 338. The thickness 334 of the end portion 322 is varied along the width 340 of the end portion 322 such that the end portion 322 has a trapezoidal cross section. The outer face 330 remains flat, and the inner face 332 can have two or more angles to create the trapezoidal cross-section. This shape reduces back radiation of the radio waves from the antenna 16, thereby improving the radiation pattern as compared to an end portion 22 having a constant thickness 34 along its width 40, particularly in the direction of the main lobe oriented in the direction of the end portion 322.

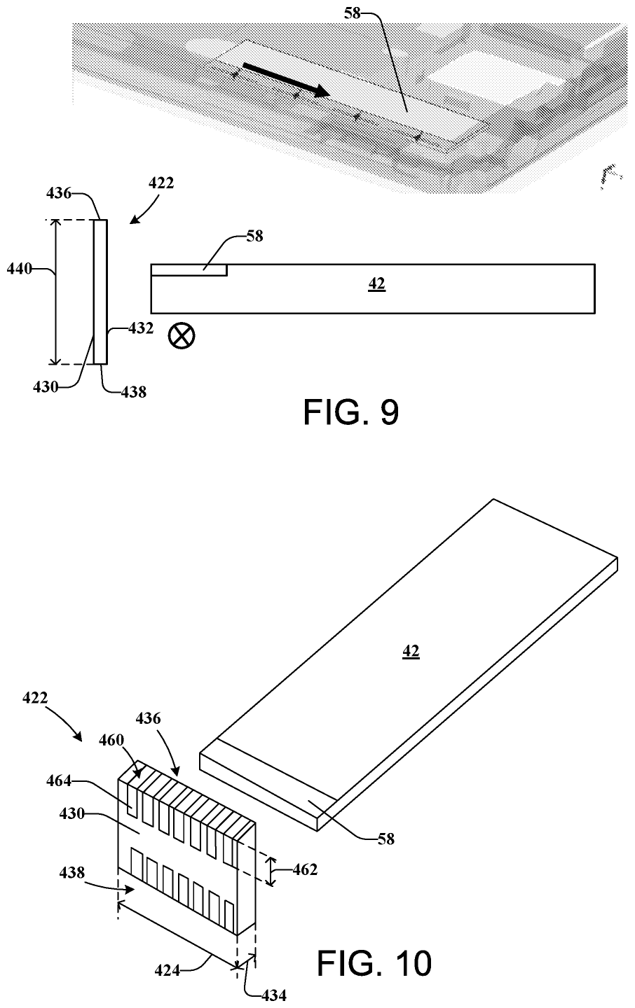

Turning now to FIGS. 9 and 10, another exemplary embodiment of an end portion for an antenna frame is shown at 422. The end portion 422 is substantially the same as the above-referenced end portion 22, and consequently the same reference numerals but indexed by 400 are used to denote structures corresponding to similar structures in the end portions. In addition, the foregoing description of the end portion 22 is equally applicable to the end portion 422 except as noted below and depicted in the figures.

The antenna 58 is horizontally polarized as indicated by the horizontal arrow shown going into the page. The antenna 58 is an edge-mounted antenna arranged substantially behind the end portion 422 of the frame 14. Using prior art antenna frames, strong reflection can be observed on the edges of the prior art end portion. However, end-fire transmission from the antenna 58 can be improved by creating a hard surface metal frame such that the electromagnetic field produced by the antenna 58 can propagate through the end portion 422 rather than being diffracted. This may be accomplished by forming corrugated or a notched top and/or bottom edge structures as part of the end portion 422.

End portion 422 includes a top edge 436 and a bottom edge 438. In order to form the corrugated or notched structure, at least one of the top edge 436 or the bottom edge 438 has a plurality of notches 460. The notches 460 are arranged along the top edge 436 and/or the bottom edge 438 and can extend in the thickness 434 direction from the outer face 430 to the inner face 432 of the end portion 422. The notches 460 can be spaced periodically along the length 424 of the end portion 422.

Notches 460 can be at least partially filled with a dielectric material 464. The dielectric material 464 can include ceramic, glass, plastic, fiberglass, or a combination thereof, among other materials. In certain embodiments, the notches 460 have a metal molding around the edges of the notches 460. The notches 460 have a depth 462 in the width 440 direction of the end portion 422. The depth 462 of the notches 460 is preferably at least one-quarter of the wavelength of the radio wave transmitted by the antenna 58 as they propagate through the dielectric material 464. For higher permittivity values of the dielectric material 464, the depth 462 of the notches 460 can be reduced because the wavelength of the radio wave as it is propagating through the dielectric material 464 is reduced. In an exemplary embodiment, the antenna 58 is transmitting radio waves with a frequency of 28 GHz and the depth 462 of the notch 460 is 1 mm when the permittivity of the dielectric material 464 is 10. Further, the notches 460 should preferably be spaced apart from each other by a distance that is less than one-quarter of the wavelength of the radio wave while propagating through the dielectric material 464. In another embodiment, the end portion 422 can have a plurality of metallic strips instead of, or in addition to, the plurality of notches 460.

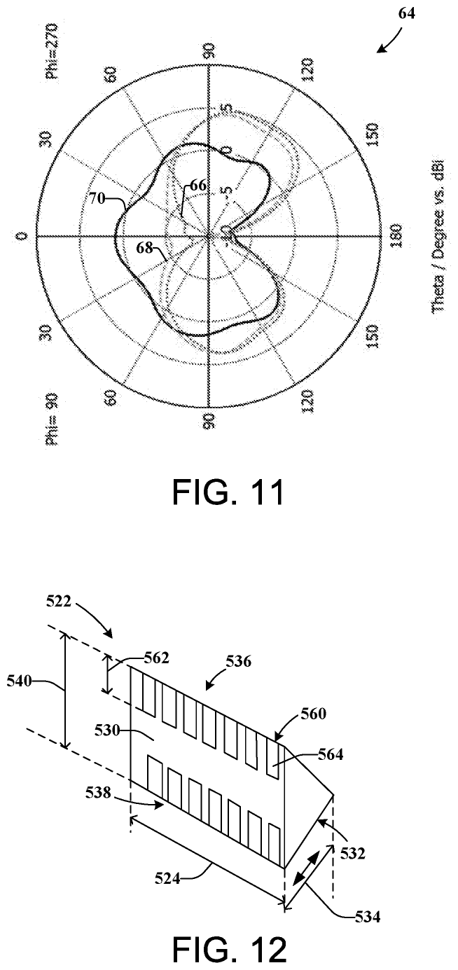

This notched edge surface or surfaces in the end portion 422 creates a hard surface boundary condition that allows horizontally polarized electromagnetic waves transmitted by the antenna 58 to propagate through the end portion 422, thereby improving the radiation pattern as compared to an end portion 22 having non-corrugated top and bottom edges, particularly in the direction of the main lobe oriented in the direction of the end portion 422. This improved radiation pattern is depicted in FIG. 11, which displays a diagram 64 showing the radiation patterns that result from using an end portion 422 having notched top and bottom edges, as compared to using various end portions 22 lacking a notched top and bottom edge. Radiation patterns 66 and 68 correspond to the use of end portions 22 having different widths 40, but lacking a notched top and bottom edge, and radiation pattern 70 corresponds to the use of end portion 422, which has notched top and bottom edges.

Turning now to FIG. 12, end portion 522 is adapted to provide improved radiation patterns for dual-polarized antennas that may contain both vertically polarized and horizontally polarized antenna elements. In one embodiment, end portion 522 has a depth 534 that varies along the width 540 such that end portion 522 has triangular-shaped cross-section similar to that of end portion 122, which reduces the radar cross section of the end portion 522 to improve the radiation pattern resulting from vertically polarized antenna elements. Further, a plurality of notches 560 are arranged along the length 524 of the end portion 522 along the top edge 536 and the bottom edge 538 to create a hard surface boundary condition to improve electromagnetic wave propagation of horizontally polarized waves to improve the radiation pattern resulting from horizontally polarized antenna elements. Notches 560 can extend from the outer face 530 to the inner face 532. It should be appreciated that an end portion designed for dual polarized antennas can employ any shape cross-section described in regards to aforementioned embodiments. For example, end portion 522 can also have an arc-shaped cross-section similar to end portion 222, or a trapezoidal-shaped cross-section similar to end portion 322.

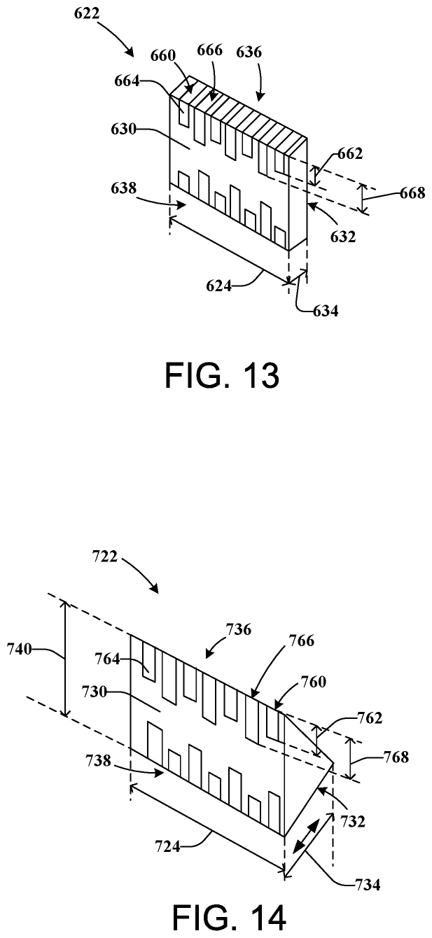

Turning now to FIG. 13, end portion 622 is substantially similar to end portion 422, except that notches 660, 666 of different depths are included to account for a horizontally polarized antenna that operates as a dual-band antenna. End portion 622 includes a top edge 636 and a bottom edge 638. In order to form the corrugated or notched structure, at least one of the top edge 636 or the bottom edge 638 has a plurality of notches 660, 666 having different depths 662, 668. First notches 660 having a first depth 662 can be alternated with second notches 666 having a second depth 668. The first depth 662 of the first notches 660 is preferably at least one-quarter of the wavelength of the radio wave transmitted by the antenna 58 on a first band as the radio wave propagates through the dielectric material 664. Similarly, the second depth 668 of the second notches 666 is preferably at least one-quarter of the wavelength of the radio wave transmitted by the antenna 58 on a second band as the radio wave propagates through the dielectric material 664. In this manner, first notches 660 provide a transmission benefit for radio waves having a first wavelength on the first band, and second notches 666 provide a transmission benefit for radio waves having a second wavelength on the second band. The notches 660, 666 are arranged along the top edge 636 and/or the bottom edge 638 and can extend in the thickness 634 direction from the outer face 630 to the inner face 632 of the end portion 622. The notches 660, 666 can be spaced periodically along the length 624 of the end portion 622.

Notches 660, 666 can be at least partially filled with a dielectric material 664. The dielectric material 664 can include ceramic, glass, plastic, fiberglass, or a combination thereof, among other materials. It should be appreciated that first notches 660 and second notches 666 can be filled with the same dielectric material 664 or different dielectric material 664, and the depths 662, 668 of the notches 660, 666 can be selected based on the dielectric material used 664. In certain embodiments, the notches 660, 666 have a metal molding around the edges of the notches 660, 666.

Turning now to FIG. 14, end portion 722 is adapted to provide improved radiation patterns for dual-polarized/dual-band antennas that contain both vertically polarized and horizontally polarized antenna elements and also communicate on two bands. In one embodiment, end portion 722 has a depth 734 that varies along the width 740 such that end portion 722 has a triangular-shaped cross-section similar to that of end portion 122, which reduces the radar cross section of the end portion 722 to improve the radiation pattern resulting from vertically polarized antenna elements. Further, a plurality of notches 760, 766 having different depths 762, 768 are arranged along the length 724 of the end portion 722 along the top edge 736 and the bottom edge 738 to create a hard surface boundary condition to improve electromagnetic wave propagation of horizontally polarized waves to improve the radiation pattern resulting from horizontally polarized antenna elements.

First notches 760 having a first depth 762 can be alternated with second notches 766 having a second depth 768. The first depth 762 of the first notches 760 is preferably at least one-quarter of the wavelength of the horizontally polarized radio wave transmitted by the antenna 58 on a first band as the radio wave propagates through the dielectric material 764. Similarly, the second depth 768 of the second notches 766 is preferably at least one-quarter of the wavelength of the radio wave transmitted by the antenna 58 on a second band as the radio wave propagates through the dielectric material 664. In this manner, first notches 760 provide a transmission benefit for radio waves having a first wavelength on the first band, and second notches 766 provide a transmission benefit for radio waves having a second wavelength on the second band. Notches 760 can extend from the outer face 730 to the inner face 732. It should be appreciated that an end portion designed for dual polarized antennas can employ any shape cross-section described in regards to aforementioned embodiments. For example, end portion 722 can also have an arc-shaped cross-section similar to end portion 222, or a trapezoidal-shaped cross-section similar to end portion 322.

Notches 760, 766 can be at least partially filled with a dielectric material 764. The dielectric material 764 can include ceramic, glass, plastic, fiberglass, or a combination thereof, among other materials. It should be appreciated that first notches 760 and second notches 766 can be filled with the same dielectric material 764 or different dielectric material 764, and the depths 762, 768 of the notches 760, 766 can be selected based on the dielectric material used 764. In certain embodiments, the notches 760, 766 have a metal molding around the edges of the notches 760, 766.

Although certain embodiments have been shown and described, it is understood that equivalents and modifications falling within the scope of the appended claims will occur to others who are skilled in the art upon the reading and understanding of this specification.

1. An antenna frame for a wireless communication device, comprising:
an end portion comprising:
a first end;
a second end spaced apart from the first end to define a length;
an outer face that extends along the length;
an inner face that extends along the length and is spaced apart from the outer face by a thickness;
a top edge extending between the inner face and the outer face in the thickness direction and between the first end and the second end in the length direction at a top of the outer and inner faces; and
a bottom edge extending between the inner face and the outer face in the thickness direction and between the first end and the second end in the length direction at a bottom of the outer and inner faces, wherein
the bottom edge is spaced apart from the top edge by a width, and the thickness of the end portion varies along the width of the end portion.

2. The antenna frame of claim 1, wherein the thickness of the end portion at the top edge and the bottom edge is less than the thickness of the end portion at any point in between the top edge and the bottom edge.

3. The antenna frame of claim 1, wherein the thickness varies along the width of the end portion such that the inner face has an arc shape, a triangular cross section, or a trapezoidal cross section.

4-6. (canceled)

7. A wireless communication device comprising the antenna frame of claim 1, wherein the antenna frame defines an interior space and the wireless communication device further comprises an antenna located within the interior space, wherein the antenna comprises one or more antenna elements that are arranged substantially behind the end portion of the antenna frame.

8. The wireless communication device of claim 7, wherein the antenna is a vertically polarized antenna with a main lobe of radiation pattern facing outward through the end portion.

9. An antenna frame for a wireless communication device, comprising:
an end portion comprising:
a first end;
a second end spaced apart from the first end to define a length;
an outer face that extends along the length;
an inner face that extends along the length and is spaced apart from the outer face by a thickness;
a top edge extending between the inner face and the outer face in the thickness direction and between the first end and the second end in the length direction at a top of the outer and inner faces; and
a bottom edge extending between the inner face and the outer face in the thickness direction and between the first end and the second end in the length direction at a bottom of the outer and inner faces, wherein at least one of the top edge or the bottom edge has a plurality of notches.

10. The antenna frame of claim 9, wherein both the top edge and the bottom edge have a plurality of notches.

11. The antenna frame (14) of claim 9, wherein the plurality of notches are spaced periodically along the length of the end portion.

12. The antenna frame of claim 9, wherein one or more of the plurality of notches are at least partially filled with a dielectric material.

13. The antenna frame of claim 12, wherein the dielectric material is ceramic, glass, plastic, fiberglass, or a combination thereof.

14. The antenna frame of claim 12, wherein the wireless communication device is configured to transmit and receive communications using radio waves having a wavelength while passing through the dielectric material, and the plurality of notches have a depth measuring at least one-quarter of the wavelength.

15. The antenna frame of claim 9, wherein the plurality of notches have a metal molding.

16. (canceled)

17. The antenna frame of claim 9, wherein the bottom edge is spaced apart from the top edge by a width, and the thickness of the end portion varies along the width of the end portion.

18. The antenna frame of claim 17, wherein the thickness of the end portion at the top edge and the bottom edge is less than the thickness of the end portion at any point in between the top edge and the bottom edge.

19. The antenna frame of claim 17, wherein the thickness varies along the width of the end portion such that the inner face has an arc shape, a triangular cross section, or a trapezoidal cross section.

20-21. (canceled)

22. The antenna frame of claim 9, wherein the plurality of notches comprises a first notch having a first depth and a second notch having a second depth.

23. The antenna frame of claim 22, wherein the wireless communication device is configured to transmit and receive communications using radio waves having a first wavelength while passing through the dielectric material and radio waves having a second wavelength while passing through the dielectric material, and the first depth measuring at least one-quarter of the first wavelength and the second depth measuring at least one-quarter of the second wavelength.

24. A wireless communication device comprising the antenna frame of claim 9, wherein the antenna frame defines an interior space and the wireless communication device further comprises an antenna located within the interior space, wherein the antenna comprises one or more antenna elements that are arranged substantially behind the end portion of the antenna frame, and the antenna is a horizontally polarized antenna with a main lobe of radiation pattern facing outward through the end portion.

25. (canceled)

26. A wireless communication device comprising the antenna frame of claim 17, wherein the antenna frame defines an interior space and the wireless communication device further comprises an antenna located within the interior space, wherein the antenna comprises one or more antenna elements that are arranged substantially behind the end portion of the antenna frame, and the antenna is a dual-polarized antenna with a main lobe of radiation pattern facing outward through the end portion.

27. (canceled)

28. A wireless communication device comprising the antenna frame of claim 22, wherein the antenna frame defines an interior space and the wireless communication device further comprises an antenna located within the interior space, wherein the antenna comprises one or more antenna elements that are arranged substantially behind the end portion of the antenna frame, and the antenna is a dual-band antenna with a main lobe of radiation pattern facing outward through the end portion.

29-30. (canceled)
